(19) United States
(12) Patent Application Publication
(10) Pub. No.: US 2026/0162415 A1
(43) Pub. Date: Jun. 11, 2026

(54) ELECTRONIC DEVICE AND OBJECT DETECTION METHOD THEREOF

(71) Applicant: HIMAX TECHNOLOGIES LIMITED, Tainan City (TW)

(72) Inventors: Bo-Ying Huang, Tainan City (TW); Tzu-Hsu Chen, Tainan City (TW); Ti-Wen Tang, Tainan City (TW)

(73) Assignee: HIMAX TECHNOLOGIES LIMITED, Tainan City (TW)

(21) Appl. No.: 18/976,218

(22) Filed: Dec. 10, 2024

(51) Int. Cl. G06V 10/82; G06V 10/36; G06V 10/94

(52) U.S. Cl. CPC G06V 10/82; G06V 10/36; G06V 10/955

(57) ABSTRACT

A object detection method includes: receiving a plurality of blocks of the image information; performing a block-based discrete cosine transform (DCT) on a plurality of blocks to obtain a plurality of DCT-coefficient blocks respectively, wherein the DCT-coefficient block comprises a DC coefficient and a plurality of AC coefficients corresponding to difference frequencies; performing a Zig-Zag scanning operation on the plurality of DCT-coefficient blocks to obtain a plurality of DCT-coefficient strips respectively; concatenating at least two different DCT-coefficient strips as a modified DCT-coefficient strip; and performing an object detection operation by feeding the modified DCT-coefficient strip to a convolution neural network device.

### BACKGROUND

### Technical Field

The disclosure relates to an electronic device and an object detection method thereof, and more particularly, to the object detection method which can reduce memory usage of the electronic device.

### Description of Related Art

With an advancement of deep learning technology, an object detection operation is widely performed by applying the deep learning technology. Through a deep learning operation, electronic device can find important elements and/or features from image information with a large number of pictures and tags, and effectively determines which important categories the pictures belong to. In conventional art, YOLO algorithm is widely applied in the object detection operation. In the conventional art, large mount memory usage is necessary for performing the object detection operation. That is, a higher cost and higher power consumption may be caused during the object detection operation.

### SUMMARY

The disclosure provides an electronic device and an object detection method thereof which can reduce memory usage for performing the object detection method.

The object detection method includes: receiving image information; performing a block-based discrete cosine transform (DCT) on each of a plurality of blocks of the image information to obtain a DCT-coefficient block of each of the blocks, wherein the DCT-coefficient block includes a DC coefficient and a plurality of AC coefficients corresponding to difference frequencies; performing a Zig-Zag scanning operation on the DCT-coefficient block to obtain a plurality of DCT-coefficient strips; and performing an object detection operation by feeding the modified DCT-coefficient strip to a convolution neural network device.

The electronic device includes a first processing circuit, a second processing circuit and a convolution neural network device. The first processing circuit receives image information, and performs a block-based discrete cosine transform (DCT) on each of a plurality of blocks of the image information to obtain a DCT-coefficient block of each of the blocks, wherein the DCT-coefficient block includes a DC coefficient and a plurality of AC coefficients corresponding to different to difference frequencies. The second processing circuit performs a Zig-Zag scanning operation on the DCT-coefficient block to obtain a plurality of DCT-coefficient strips, and concatenates at least two different DCT-coefficient strips as a modified DCT-coefficient strip. The convolution neural network device receives the modified DCT-coefficient strip for performing an object detection operation.

Based on the above, the object detection method of present disclosure uses DCT frequency domain coefficients as input, and re-ranges a sequence of the DCT frequency domain coefficients to the DCT-coefficient strip to generate a modified DCT-coefficient strip. Furthermore, the modified DCT-coefficient strip can be fed to a convolution neural network device, and the object detection operation can be performed by the convolution neural network device according to the modified DCT-coefficient strip. Such as that, a memory usage can be reduced by using the object detection method of present disclosure.

### BRIEF DESCRIPTION OF THE DRAWINGS

FIG. 1 illustrates a flow chart of an object detection method according to an embodiment of present disclosure

FIG. 2 to FIG. 7 illustrate schematic diagrams for performing an objection detection operation according to an embodiment of present disclosure.

FIG. 8 illustrates a block diagram of an electronic device according to an embodiment of preset disclosure.

### DETAILED DESCRIPTION OF DISCLOSED EMBODIMENTS

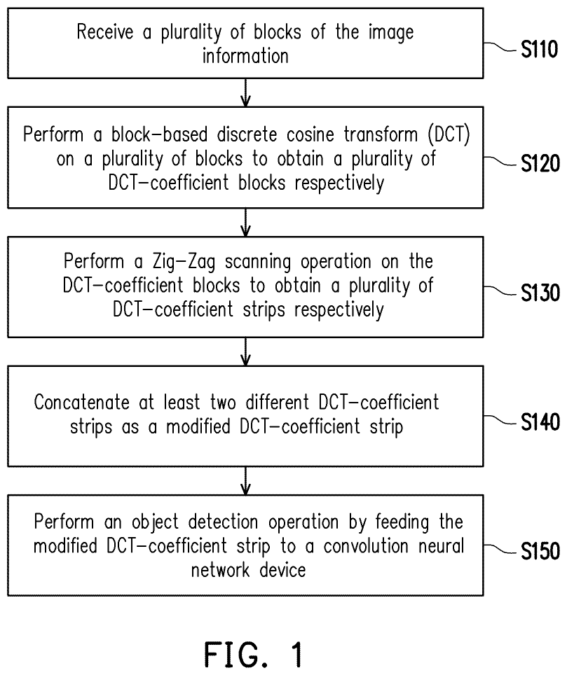

Please refer to FIG. 1, which illustrates a flow chart of an object detection method according to an embodiment of present disclosure. The object detection method of presented embodiment may be used for a deep learning object detection operation. In a step S110, an image information can be received by an electronic device, wherein the image information may be a frame in BGB or YCbCr color space. Specifically, the present embodiment is described by taking projection onto the YCbCr color space as an example. Divide one channel of the frame (such as luminance frame, named Y frame) into a plurality of blocks (e.g., each of the blocks may be a 8 x8 pixel block). In a step S120, the electronic device may perform a block-based discrete cosine transform (DCT) on each of the plurality of blocks of the image information to obtain a plurality of first DCT-coefficient blocks (e.g., each of the DCT-coefficient blocks may be a 8×8 coefficient block) of each of the blocks of the image information. In this embodiment, each of the first DCT-coefficient blocks may have a DC (direct current) coefficient and a plurality of AC (alternating current) coefficients. Moreover, the DC coefficient and the AC coefficients may be in a frequency sequential from a first position (i.e., upper/top left) to a second position (i.e., lower/bottom right) of each of the first DCT-coefficient blocks.

In a step S130, in this embodiment, a scanning operation may be performed on each of the first DCT-coefficient blocks to obtain a plurality of DCT-coefficient strips. The scanning operation may be performed from the first position to the second position of each of the first DCT-coefficient blocks with a Zig-Zag scanning manner.

In a step S140, a concatenating operation can be operated on the DCT-coefficient strips for generating a modified DCT coefficient strip. In detail, in this embodiment, at least one of the DCT-coefficient strips generated by the step S130 may be selected to be concatenating into the modified DCT coefficient strip. In one embodiment, all coefficients of the at least one selected DC-coefficient strip may be used to generate the modified DCT coefficient strip. Or, in some embodiments, only coefficients corresponding to relative low frequencies (including zero frequency) are used to generate the modified DCT coefficient strip.

In the step S140, at least two of the DCT coefficient strips can be selected, and the selected at least two of the DCT coefficient strips may be concatenated to generate the modified DCT coefficient strip. In a step S150, the modified DCT coefficient strip can be fed to a convolution neural network (CNN) device, and the CNN device may perform an object detection operation on the image information according to the modified DCT coefficient strip.

In this embodiment, the electronic device performs the object detection operation by using frequency domain information of the processed image information. The electronic device further re-arranges the DCT-coefficient block to modified DCT-coefficient strips. The CNN device of the electronic device may perform the object detection operation according to the modified DCT-coefficient strip. Such as that, data amount of the object detection operation can be reduced, and memory usage of the electronic device for performing the object detection operation can be reduced, too. Furthermore, chip size and power consumption of the electronic device can be saved.

In this embodiment, by implementing the object detection operation in YOLOV8n, significant reductions in memory usage can be achieved up to 70%.

Please refer to FIG. 2 to FIG. 7, which illustrate schematic diagrams for performing an objection detection operation according to an embodiment of present disclosure. In FIG. 2, an image information 210 can be received by an electronic device for performing the objection detection operation. The image information 210 may include luminance information 211 (i.e. Y information), first color difference information 212 (i.e. Cb information) and second color difference information (i.e. Cr information). Each of the luminance information 211, first color difference information 212 and second color difference information may be divided into a plurality of blocks. For example, the luminance information 211 may be divided into blocks B00 to Bnm in FIG. 2. In more detail, the luminance information 211 of an image may be divided into (n+1)*(m+1) blocks B00 to Bnm, where n and m are positive integers. The block B00 denotes that a block is at a first position (i.e. top-left) (0,0) of the image. The block Bnm denotes that a block is at a second position (i.e. bottom right) (n, m) of the image. In preset embodiment, each of the blocks B00 to Bnm (may have 8×8 pixels) of the luminance information 211 may be selected to be a processed block 220.

Besides, the image information 210 may be converted by an original image information with red color, green color and blue color (RGB) model. The conversion operation may be operated in the electronic device or external from the electronic device, and no special limitation here.

In this embodiment, a dimension of each of the blocks B00 to Bnm of the luminance information 211 may be determined by an engineer according to necessary object detection resolution, and no more special limitation here.

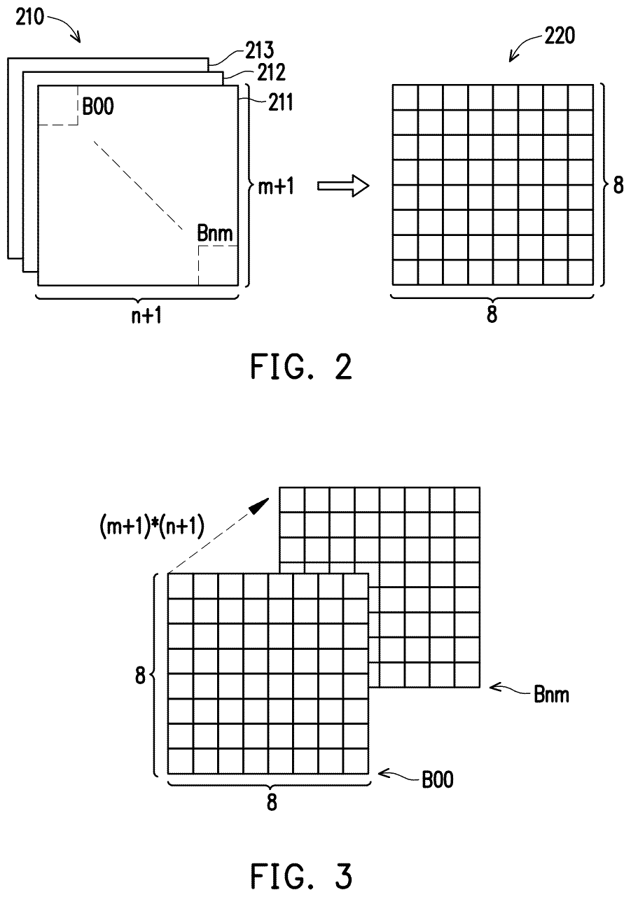

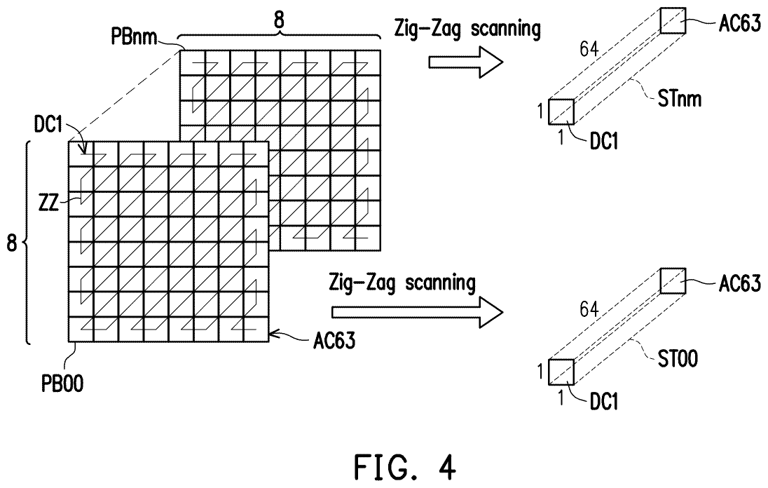

In FIG. 3, the blocks B00 to Bnm may be selected out, and the electronic device may perform a block-based discrete cosine transform (DCT) on each of a plurality of blocks B00 to Bnm to generate preliminary DCT-coefficient blocks PB00 to PBnm respectively corresponding to the blocks B00 to Bnm as illustrate in FIG. 4. The DCT is well known by a person skilled in the art, and no more description here. In this embodiment, each of the preliminary DCT-coefficient blocks PB00 to PBnm may be an 8×8 block, and each of the preliminary DCT-coefficient blocks PB00 to PBnm may has 8×8 coefficients. The coefficients of the preliminary DCT-coefficient block PB00 respectively corresponding to different frequency components (such as DC1, AC01, AC02 . . . and AC63) of the block B00, and so on, the coefficients of the preliminary DCT-coefficient block PBnm respectively corresponding to different frequency components (such as DC1, AC01, AC02 . . . and AC63) of the block Bnm.

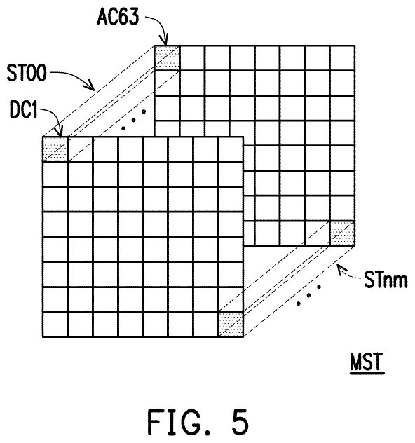

In FIG. 4, each of the preliminary DCT-coefficient blocks (with 8×8 coefficients) PB00 to PBnm has a plurality of DCT-coefficients respectively corresponding to different frequency components (such as DC1, AC01, AC02 . . . and AC63). A first DCT-coefficient DC1 (top left) is a DC coefficient and the other DCT-coefficients may be AC coefficients. The DC coefficient is corresponding to zero frequency, and the AC coefficients are corresponding to non-zero frequencies. In FIG. 4, the AC coefficient AC63 (bottom right) may be the AC coefficient corresponding to a highest frequency. In this embodiment, the electronic device performs a Zig-Zag scanning operation according to frequency value from low to high on the DCT-coefficients of each of the preliminary DCT-coefficient blocks PB00 to PBnm, and a plurality of DCT-coefficient strips ST00 to STnm corresponding to the preliminary DCT-coefficient blocks PB00 to PBnm are generated respectively. In more detail, the Zig-Zag scanning operation re-arranges the preliminary DCT-coefficient block PB00 (8×8) as the DCT-coefficient strip ST00 (1×1×64) by a sore order ZZ from top left to bottom right. Therefore, the coefficients of each DCT-coefficient strip are sorted by frequency from low (i.e., DC) to high (i.e., AC63) in a line. The plurality of DCT-coefficient strips ST00 to STnm are collected as a macro strip MST as illustrated in FIG. 5. The DCT-coefficient strip will hereafter be cited within the text as the strip for brevity.

In FIG. 5, the DCT-coefficient strips ST00 to STnm are arranged from top left to bottom right to form the macro strip MST.

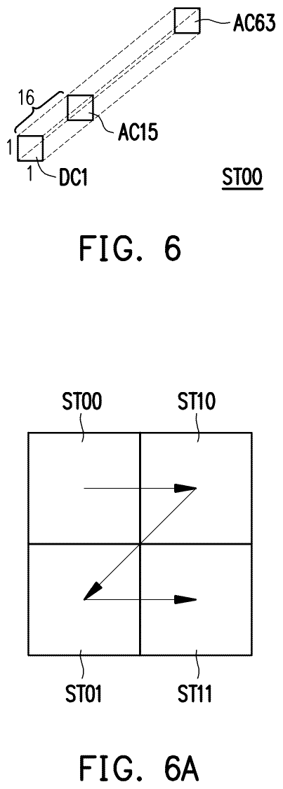

In FIG. 6, the electronic device may select entire or partial of each of the DCT-coefficient strips ST00 to STnm to perform the concatenating operation. In some embodiments, the electronic device may select out 16 coefficients respectively corresponding to relatively low frequencies DC1 to AC15 of each of the DCT-coefficient strips ST00 to STnm for performing the concatenating operation. In detail, the electronic device may set a threshold frequency (=AC15), and set a setting frequency range between the threshold frequency and a zero frequency (=DC1). Furthermore, the electronic device may select the coefficients of the strip among the setting frequency range for performing the concatenating operation.

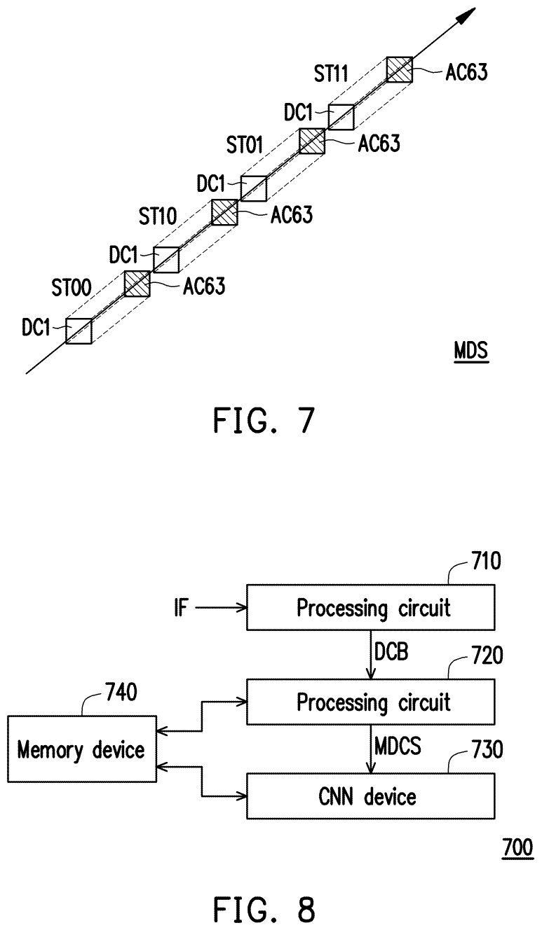

In FIG. 6A, during the concatenating operation, the electronic device may select 4 neighboring strips such as the DCT-coefficient strips ST00, ST10, ST01 and ST11 as a group and concatenate in Z order to generated a modified DCT-coefficient strip. In FIG. 7, The electronic device may, in sequential, rearrange the DCT-coefficient strips ST00, ST10, ST01 and ST11 into a modified DCT-coefficient strip MDS. The DCT-coefficient strips ST00, ST10, ST01 and ST11 may be arranged in a same row and arranged in a length direction.

In this embodiment, the electronic device may select the DCT-coefficient strips ST00, ST10, ST01 and ST11 into a group, firstly. Then, the electronic device may connect the DCT-coefficient strips ST00, ST10, ST01 and ST11 within a same group in series to generate the corresponding modified DCT-coefficient strip MDS.

In some embodiments, the electronic device may select the DCT-coefficient strips into a plurality of groups. In this case, the electronic device may connect the DCT-coefficient strips of each of the groups in series to generate corresponding modified DCT-coefficient strip. That is, a plurality of modified DCT-coefficient strip may be generated.

The modified DCT-coefficient strip MDS may be received by a convolution neural network (CNN) device. The CNN device may perform object detection operation according to the modified DCT-coefficient strip MDS by a deep learning object detection algorithm. In this embodiment, the deep learning object detection algorithm may be well known by a person skilled in the art, and no more special limitation here.

Please refer to FIG. 8, which illustrates a block diagram of an electronic device according to an embodiment of preset disclosure. The electronic device 700 includes processing circuits 710 and 720, a convolution neural network (CNN) device 730 and a memory device 740. The processing circuit 710 receives image information IF, and performs a block-based discrete cosine transform (DCT) on each of a plurality of blocks of the image information IF to obtain a DCT-coefficient block DCB of each of the blocks. In this embodiment, the DCT-coefficient block includes a DC coefficient and a plurality of AC coefficients corresponding to different to difference frequencies. The processing circuit 720 is configured to perform a Zig-Zag scanning operation on the DCT-coefficient block to obtain a DCT-coefficient strip. The processing circuit 720 is coupled to the processing circuit 710. The processing circuit 720 further concatenates at least two different DCT-coefficient strips as a modified DCT-coefficient strip MDCS.

The CNN device 730 is coupled to the processing circuit 720. The CNN device 730 receives the modified DCT-coefficient strip MDCS for performing an object detection operation to detect object information of the image information IF.

Detail operations of the processing circuits 710 and 720, the CNN device 730 have been described in the embodiments mentioned above, and no more repeated description here.

The memory device 740 is coupled to the processing circuit 720 and the CNN device. The memory device 740 is configured to store necessary data and/or temporary data for the object detection operation, and can be accessed by the processing circuit 720 and the CNN device.

In this embodiment, the processing circuit 710 may be a central processing unit (CPU), the processing circuit 720 may be another CPU, too. The CNN device 730 may be a neural processing unit (NPU). The CPU and the NPU may be implemented by semiconductor circuit such as chips. Alternatively, in some embodiment, each of the processing circuits 710 and 720 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC).

The memory device 740 may be a static memory circuit. Of course, in some embodiments, the memory device 740 may be any memory circuit well known by a person skilled in the art.

In summary, the electronic device of present disclosure receives DCT frequency domain coefficients as input, and re-arranges the received DCT frequency domain coefficients to a modified strip. By feeding the modified strip to a CNN device for operating object detection, memory usage of the electronic device can be saved.

What is claimed is:

1. An object detection method, comprising:
receiving a plurality of blocks of the image information;
performing a block-based discrete cosine transform (DCT) on a plurality of blocks to obtain a plurality of DCT-coefficient blocks respectively, wherein the DCT-coefficient block comprises a DC coefficient and a plurality of AC coefficients corresponding to difference frequencies;
performing a Zig-Zag scanning operation on the plurality of DCT-coefficient blocks to obtain a plurality of DCT-coefficient strips respectively; and
concatenating at least two different DCT-coefficient strips as a modified DCT-coefficient strip; and
performing an object detection operation by feeding the modified DCT-coefficient strip to a convolution neural network device.

2. The object detection method according to claim 1, further comprising:
obtaining a partial DCT-coefficient strip by extracting information of the DCT-coefficient block among a setting frequency range.

3. The object detection method according to claim 2, further comprising:
setting a threshold frequency; and
setting the setting frequency range between the threshold frequency and a zero frequency.

4. The object detection method according to claim 3, wherein step of concatenating the at least two different DCT-coefficient strips as the modified DCT-coefficient strip comprises:
arranging, in a length direction, the at least two neighboring DCT-coefficient strips to generate the modified DCT-coefficient strip;
wherein the DC coefficient of one of the neighboring DCT-coefficient strips is concatenated next to the most-frequency AC coefficient of another the neighboring DCT-coefficient strip.

5. An electronic device, comprising:
a first processing circuit, receiving image information, and performing a block-based discrete cosine transform (DCT) on each of a plurality of blocks of the image information to obtain a DCT-coefficient block of each of the blocks, wherein the DCT-coefficient block comprises a DC coefficient and a plurality of AC coefficients corresponding to different to difference frequencies;
a second processing circuit, performing a Zig-Zag scanning operation on the DCT-coefficient block to obtain a plurality of DCT-coefficient strips, and concatenating at least two different DCT-coefficient strips as a modified DCT-coefficient strip; and
a convolution neural network device, receiving the modified DCT-coefficient strip for performing an object detection operation.

6. The electronic device according to claim 5, further comprising:
a memory device, coupled to the second processing circuit and the convolution neural network device, for storing data for an object detection operation.

7. The electronic device according to claim 5, wherein the memory device is a static memory circuit.

8. The electronic device according to claim 5, wherein the second processing circuit is configured to:
obtain a partial DCT-coefficient strip by extracting information of the DCT-coefficient block among a setting frequency range.

9. The electronic device according to claim 8, wherein the second processing circuit is further configured to:
set a threshold frequency; and
set the setting frequency range between the threshold frequency and a zero frequency.

10. The electronic device according to claim 5, wherein the second processing circuit is further configured to:
arrange, in a length direction, the at least two neighboring DCT-coefficient strips to generate the modified DCT-coefficient strip,
wherein the DC coefficient of one of the neighboring DCT-coefficient strips is concatenated next to the most-frequency AC coefficient of another the neighboring DCT-coefficient strip.

11. The electronic device according to claim 5, wherein the first processing circuit is a first central processing unit, the second processing circuit is a second central processing unit, and the convolution neural network device comprises a neural processing unit.
